(19) United States
(12) Patent Application Publication
(10) Pub. No.: US 2012/0238279 A1
(43) Pub. Date: Sep. 20, 2012

(54) TRANSMISSION POWER COORDINATION FOR SMALL-COVERAGE BASE STATIONS

(75) Inventors: Liwen YU, San Diego, CA (US); Farhad Meshkati, San Diego, CA (US); Mehmet Yavuz, San Diego, CA (US); Sumeeth Nagaraja, San Diego, CA (US); Yi Jiang, San Diego, CA (US); Varun Khaitan, San Diego, CA (US); Yeliz Tokgoz, San Diego, CA (US)

(73) Assignee: QUALCOMM Incorporated, San Diego, CA (US)

(21) Appl. No.: 13/246,831

(22) Filed: Sep. 27, 2011

Related U.S. Application Data
(60) Provisional application No. 61/387,428, filed on Sep. 28, 2010.
(60) Provisional application No. 61/423,539, filed on Dec. 15, 2010.

(51) Int. Cl. H04W 52/22; H04W 16/32

(52) U.S. Cl. 455/449; 455/522

(57) ABSTRACT

Coordinating transmission power for small-coverage base stations deployed in a wireless communication network may comprise, for example, receiving a plurality of measurement reports corresponding to two or more base stations, determining a coordinated coverage condition for the base stations, and setting a transmission power for at least one of the base stations based on the measurement reports and the coverage condition.

### CLAIM OF PRIORITY UNDER 35 U.S.C. §119

The present Application for Patent claims priority to Provisional Application No. 61/387,428 entitled “APPARATUS AND METHOD FOR FEMTOCELL POWER CALIBRATION” filed Sep. 28, 2010, having Attorney Docket No. 102938P1, and Provisional Application No. 61/423,539 entitled “APPARATUS AND METHOD FOR FEMTOCELL POWER CALIBRATION” filed Dec. 15, 2010, having Attorney Docket No. 102938P2, each assigned to the assignee hereof and each hereby expressly incorporated by reference herein.

### FIELD OF DISCLOSURE

The present disclosure relates generally to wireless communications, and more particularly to coordinating transmission power for small-coverage base stations deployed in a wireless communication network.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, orthogonal frequency division multiple access (OFDMA) systems, and so on.

Generally, a wireless multiple-access communication system is capable of simultaneously supporting communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. These communication links may be established via a single-in-single-out, multiple-in-signal-out, or a multiple-in-multiple-out (MIMO) system.

To supplement conventional mobile phone network base stations (commonly referred to as macrocell base stations, NodeBs, etc.), additional small-coverage base stations may be deployed to provide more robust wireless coverage for the wireless terminals. These small-coverage base stations may be commonly referred to as access point base stations, Home NodeBs, femto access points, femtocells, etc., and may be deployed for incremental capacity growth, richer user experience, in-building coverage, or the like. Typically, such small-coverage base stations are connected to the Internet and the mobile operator's network via a broadband connection, such as a digital subscriber line (DSL) router, cable or other modem, etc. Small-coverage base stations may also provide additional or enhanced services (e.g., increased bandwidth, unlimited access, access to other devices, etc.) to one or more wireless terminals.

Deployment of small-coverage base stations, however, may cause interference to macrocell base stations that provide wireless coverage in the area of deployment, as well as to neighboring small-coverage base stations themselves. There is therefore a need in the art for improved coordination among small-coverage base stations deployed in a given wireless communication network.

### SUMMARY

Exemplary embodiments of the invention are directed to systems and methods for coordinating transmission power for small-coverage base stations deployed in a wireless communication network.

In one aspect, a method is disclosed for coordinating transmission power for small-coverage base stations deployed in a wireless communication network. The method may comprise, for example, receiving a plurality of measurement reports corresponding to two or more base stations, determining a coordinated coverage condition for the base stations, and setting a transmission power for at least one of the base stations based on the measurement reports and the coverage condition.

In another aspect, an apparatus is disclosed for coordinating transmission power for small-coverage base stations deployed in a wireless communication network. The apparatus may comprise, for example, at least one processor and memory coupled to the at least one processor. The at least one processor may be configured to receive a plurality of measurement reports corresponding to two or more base stations, determine a coordinated coverage condition for the base stations, and set a transmission power for at least one of the base stations based on the measurement reports and the coverage condition.

In yet another aspect, another apparatus is disclosed for coordinating transmission power for small-coverage base stations deployed in a wireless communication network. The apparatus may comprise, for example, means for receiving a plurality of measurement reports corresponding to two or more base stations, means for determining a coordinated coverage condition for the base stations, and means for setting a transmission power for at least one of the base stations based on the measurement reports and the coverage condition.

In yet another aspect, a computer-readable medium is disclosed that comprises code, which, when executed by a processor, causes the processor to perform operations for coordinating transmission power for small-coverage base stations deployed in a wireless communication network. The computer-readable medium may comprise, for example, code for receiving a plurality of measurement reports corresponding to two or more base stations, code for determining a coordinated coverage condition for the base stations, and code for setting a transmission power for at least one of the base stations based on the measurement reports and the coverage condition.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates an exemplary communication system to enable deployment of femto nodes within a network environment.

FIG. 2 illustrates an example wireless communication system for adjusting transmission power of one or more base stations.

FIG. 3 illustrates an example methodology that sets a transmit power for one or more base stations based at least in part on received measurement reports.

FIG. 4 illustrates an example system for determining a transmit power for one or more base stations based at least in part on received measurement reports.

FIG. 5 illustrates a multiple access wireless communication system according to one embodiment.

FIG. 6 illustrates a block diagram of a communication system.

FIG. 7 illustrates a wireless communication system, configured to support a number of users, in which the teachings herein may be implemented.

### DETAILED DESCRIPTION

Various embodiments of the present invention are described below with reference to the drawings, where like reference numerals are used to refer to like elements throughout. It will be appreciated that the term “embodiments of the invention” does not require that all embodiments of the invention include the discussed feature, advantage, or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

The techniques described herein may be used for various wireless communication systems such as code division multiple access (CDMA) systems, time division multiple access (TDMA) systems, frequency division multiple access (FDMA) systems, 3GPP Long Term Evolution (LTE) systems, orthogonal frequency division multiple access (OFDMA) systems, and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP LTE is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, or any other short- or long-range, wireless communication techniques.

Various aspects or features will now be presented in more detail in terms of systems that may include a number of devices, components, modules, and the like. It is to be understood and appreciated that the various systems may include additional devices, components, modules, etc., and may or may not include all of the devices, components, modules, etc., discussed in connection with the figures. A combination of these approaches may also be used.

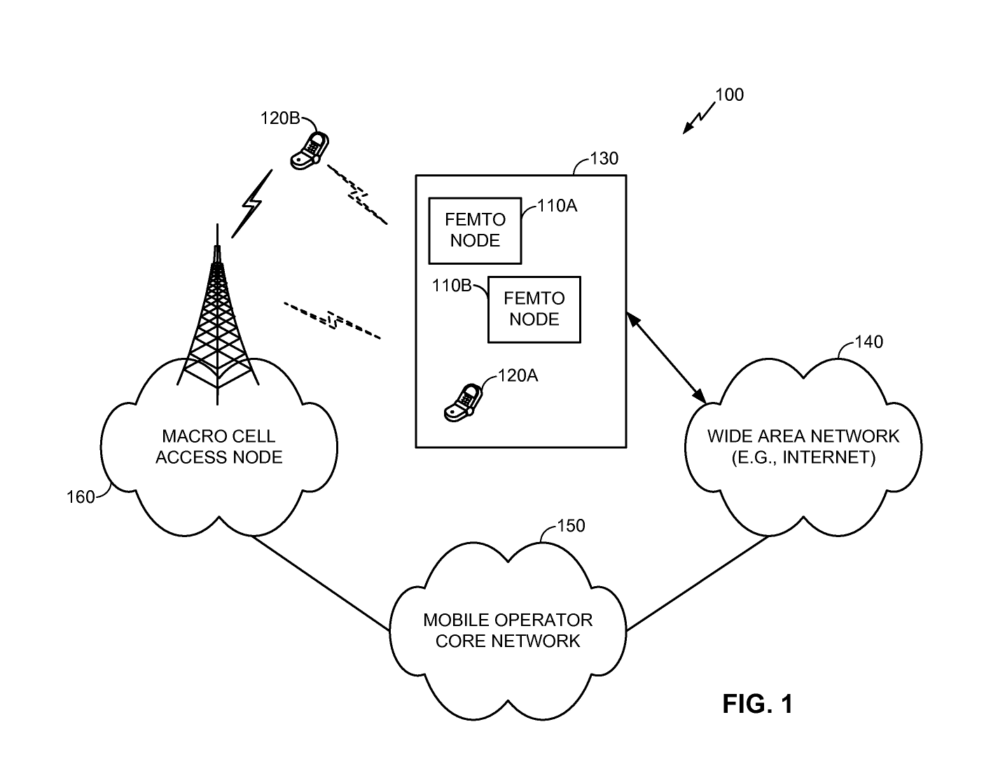

FIG. 1 illustrates an exemplary communication system 100 where one or more femto base stations 110 are deployed as small-coverage base stations within a wireless network environment. The system 100 includes a macro base station 160 (or macro node) for connecting access terminals 120 to a mobile operator core network 150. In addition, the system 100 includes multiple femto base stations 110 (or Home Node Bs (HNBs)), such as femto base stations 110A and 110B, installed in a relatively small scale network environment, such as in one or more floors of a user office building 130. Each femto base station 110 may be coupled to a wide area network 140 (e.g., the Internet) and a mobile operator core network 150 via a digital subscriber line (DSL) router, a cable modem, a wireless link, or other connectivity means (not shown). Each femto base station 110 may be configured to serve access terminals 120 in its corresponding coverage area (e.g., access terminal 120A), while other access terminals 120 (e.g., access terminal 120B) may be served by the macro base station 160 of the mobile operator core network 150 alone, or by other base stations (not shown). The access terminals 120 may thus be capable of operating both in macro environments and smaller scale (e.g., office or residential) network environments.

The owner of the femto base stations 110 may subscribe to mobile services, such as, for example, 3G or 4G mobile services, offered through the mobile operator core network 150. Thus, for example, depending on the current location of an access terminal 120, the access terminal 120 may be served by the macro base station 160 of the mobile operator core network 150 or by one of the femto base stations 110 (e.g., the femto base stations 110A and 110B that reside within the office building 130). For example, when a subscriber is outside her office or residence, she may be served by a standard macro base station (e.g., base station 160) and when the subscriber is inside her office or residence, she may be served by a femto base station (e.g., base station 110A or 110B). It should be appreciated that femto base stations 110 may be made backward compatible with existing access terminals 120.

Each femto base station 110 may be deployed on a single frequency, or, in the alternative, on multiple frequencies. Depending on the particular configuration, the single frequency or one or more of the multiple frequencies may overlap with one or more frequencies used by a macro base station (e.g., base station 160).

In some designs, an access terminal 120 may be configured to connect to a preferred femto base station (e.g., an office femto base station of the access terminal 120) whenever such connectivity is possible. For example, whenever the access terminal 120 is within the user's office building 130, it may communicate with one of the femto base stations 110. If the access terminal 120 operates within the macro cellular network but is not residing on its most preferred network (e.g., as defined in a preferred roaming list), the access terminal 120 may continue to search for the most preferred network (e.g., the preferred femto base station(s) 110) using a Better System Reselection (BSR), for example, which may involve a periodic scanning of available systems to determine whether better systems are currently available, and take subsequent efforts to associate with such preferred systems. With acquisition entry, the access terminal 120 may limit the search for a specific band and channel. The search for the most preferred system may be repeated periodically. Upon discovery of a preferred femto base station 110, the access terminal 120 may select the femto base station 110 for camping within its coverage area.

A femto base station may be restricted in some respects. For example, a given femto base station may only provide certain services to certain access terminals. In deployments with so-called restricted (or closed) association, a given access terminal may only be served by the macrocell mobile network and a defined set of femto base stations (e.g., the femto base stations 110 that reside within the corresponding user office building 130). In some implementations, a base station may be restricted to not provide, for at least one base station, at least one of signaling, data access, registration, paging, or service. A restricted femto base station (which may also be referred to as a Closed Subscriber Group Home Node B) is thus one that provides service to a restricted provisioned set of access terminals. This set may be temporarily or permanently extended as necessary. In some implementations, a Closed Subscriber Group (CSG) may be defined as the set of base stations (e.g., femto base stations) that share a common access control list of access terminals. A channel on which all femto base stations (or all restricted femto base stations) in a region operate may be referred to as a femto channel.

Various relationships may therefore exist between a given femto base station and a given access terminal. For example, from the perspective of an access terminal, an open femto base station may refer to a femto base station with no restricted association. A restricted femto base station may refer to a femto base station that is restricted in some manner (e.g., restricted for association and/or registration). A home femto base station may refer to a femto base station on which the access terminal is authorized to access and operate. A guest femto base station may refer to a femto base station on which an access terminal is temporarily authorized to access or operate on. An alien femto base station may refer to a femto base station on which the access terminal is not authorized to access or operate, except for perhaps emergency situations (e.g., 911 calls). From a restricted femto base station perspective, a home access terminal may refer to an access terminal that is authorized to access the restricted femto base station. A guest access terminal may refer to an access terminal with temporary access to the restricted femto base station. An alien access terminal may refer to an access terminal that does not have permission to access the restricted femto base station, except for perhaps emergency situations, for example, such as 911 calls (e.g., an access terminal that does not have the credentials or permission to register with the restricted femto base station).

For convenience, the discussion above referred to various functionality in the context of a femto base station. It should be appreciated, however, that other small-coverage base stations, such as a pico base station, may provide the same or similar functionality for a larger coverage area. For example, a pico base station may be restricted, a home pico base station may be defined for a given access terminal, and so on.

As discussed in the background above, deployment of small-coverage base stations such as femto base stations 110 may cause interference to macrocell base stations (e.g., macro base station 160) that provide wireless coverage in their area of deployment, as well as to neighboring small-coverage base stations themselves (e.g., other femto base stations 110). Accordingly, methods, systems, devices, and techniques are provided herein that offer improved transmission power coordination among small-coverage base stations deployed in a given wireless communication network. For example, as discussed in more detail below, a centralized algorithm may be utilized such that measurement reports are received by a central entity, which may make joint decisions according to a coordinated coverage condition regarding transmission powers for a group of femtocells deployed in concert, or at least a subset thereof. In one example, a coordination algorithm may include power calibration according to measurement reports received by a technician device moving along a route about areas covered by two or more femtocell base stations. A tradeoff between satisfying femtocell coverage levels and the impact on macrocell coverage in the same or a different area may also be determined and additionally utilized in determining a transmit power for the femtocell.

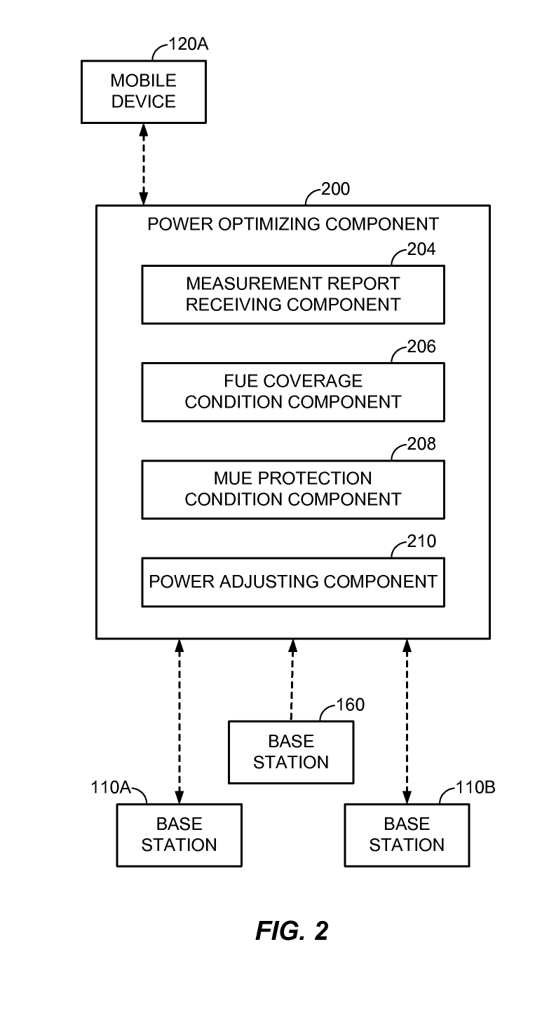

FIG. 2 illustrates an example power optimizing component 200 for coordinating transmission power for small-coverage base stations to reduce interference and improve coverage. The power optimizing component 200 is shown operating in the context of the system 100 of FIG. 1. As discussed above, the femto base stations (sometimes referred to as femtocell base stations) 110 may at least partially interfere (or potentially interfere) with the macro base station (sometimes referred to as a macrocell base station) 160, as well as each other. The power optimizing component 200 therefore operates as a centralized intermediary between the femto base station 110A, the femto base station 110B, and the macro base station 160. It will be appreciated that the particular number of base stations shown in FIG. 2 has been selected for illustration purposes only, and that the number and arrangement of these base stations may vary from system to system.

The power optimizing component 200 may exist as a stand-alone entity, or as a centralized entity within one or more of the femto base stations 110 themselves. In either case, the power optimizing component 200 may be configured to control the transmission power of at least one of the femto base stations 110 in order to coordinate base station coverage. In one example, the power optimizing component 200 may exist in one of the femto base stations 110 (e.g., femto base station 110A), which may act as an anchor or controlling base station, and control the transmission power of a different femto base station (e.g., femto base station 110B) as well as its own transmission power. Alternatively, each of the femto base stations 110 may include their own power optimizing component 200 in a distributed scheme. For illustration purposes, however, only one power optimizing component 200 is shown in FIG. 2.

According to one example, the power optimizing component 200 may adjust transmission power to satisfy a coordinated coverage condition for the femto base stations 110. Here, the femto base stations 110 may be deployed in concert to extend the coverage of the macro base station, such that a given access terminal is permitted or authorized to access either the femto base station 110A or the femto base station 110B. The coverage condition may include, for example, certain joint coverage requirements of the femto base stations 110 at the edge of their respective coverage ranges. The power optimizing component 200 may determine power adjustments for at least one of the femto base stations 110 to satisfy the coverage condition based on measurement reports for the femto base stations 110, and may accordingly provide power calibration commands to the femto base stations 110. For example, where coverage of the macro base station 160 is weak within a related cell, the femto base stations 110 may lower their transmit power so that they do not interfere (or at least, do not interfere as much) with the macro base station 160.

The power optimizing component 200 may receive measurement reports for each of the femto base stations 110, either directly or indirectly, from a mobile device 120A connected to a corresponding one of the femto base stations 110. The mobile device 120A may be an ordinary access terminal as discussed above with reference to FIG. 1, and is therefore referred to with the same reference numeral, or alternatively may be any other specially programmed mobile device. In addition to receiving the measurement reports directly from the mobile device 120A, the power optimizing component 200 may receive the measurement reports indirectly from the mobile device 120A via its corresponding serving femto base station 110 (e.g., either the femto base station 110A or the femto base station 110B). During transmission power calibration or adjustment, the mobile device 120A may move throughout a coverage area, and may send measurement reports to its corresponding serving base station. In one example, a technician or other user may move throughout the coverage area with mobile device 120A (e.g., as part of a “technician walk”). Using the measurement reports, the power optimizing component 200 may calibrate transmission power to achieve the desired coordinated coverage condition(s).

In one example, the power optimizing component 200 may compute power adjustments according to an optimization procedure that, for example, attempts to ensure a percentage of measurement reports received for a given femto base station 110 indicates a quality better than a threshold value, and/or that the quality of the macro base station 160 is better than a threshold for another percentage of measurements, to achieve the aforementioned coordinated coverage condition(s). The power optimizing component 200 may perform the optimization procedure iteratively to optimize the percentages of measurement reports over the quality threshold(s) for a given period of time. It is to be appreciated that the optimization procedure may additionally or alternatively attempt to maximize a minimum quality of the macro base station 160 under a coverage constraint for a given femto base station 110, and/or maximize a minimum quality of a given femto base station 110 under the macro base station 160 quality constraints. In one example, the power optimizing component 200 may solve the optimization procedure using linear programming or other iterative mechanisms.

The power optimizing component 200 may also adjust transmission power of one or more of the femto base stations 110 to satisfy a macro protection condition to limit the impact of communications from the femto base stations 110 on transmissions of the macro base station 160. In addition, the power optimizing component 200 may measure signals from the macro base station 160 to determine a quality thereof for performing an initial network listening calibration. For example, the power optimizing component 200 may initially calibrate downlink transmit power for one or more of the femto base stations 110 using a network listen module (NLM)-based power calibration (NLPC). The femto base stations 110 may measure macro received signal strength indicators (RSSI) from the macro base station 160 and/or one or more other macro base stations (not shown), and select a power to satisfy a coverage condition and a protection condition to initially achieve certain coverage parameters while limiting interference to the macro base station 160.

Returning to the design of FIG. 2, according to one or more embodiments, the example power optimizing component 200 shown in FIG. 2 may include a measurement report receiving component 204 that obtains measurement reports related to one or more base stations, and a femto UE (FUE) coverage condition component 206 that computes a transmission power for one or more base stations (e.g., at least one of the femto base stations 110) to satisfy a coordinated FUE coverage condition. The power optimizing component 200 may also include a macro UE (MUE) protection condition component 208 that satisfies an MUE protection condition (e.g., for the macro base station 160), and a power adjusting component 210 that transmits a power adjustment command to one or more base stations based at least in part on the FUE coverage condition, the measurement reports, and/or the MUE protection condition.

In general, the measurement report receiving component 204 may receive measurement report messages (MRM) from the mobile device 120A and/or the femto base stations 110. The FUE coverage condition component 206 and the MUE protection condition component 208 may select transmission powers based on conditions related to measurements received in areas of desired femto coverage (e.g., inside of a building or in an area of the building), areas where femto coverage is not desired and/or macrocell protection is desired (e.g., outside of the building or a different area of the building), or the like. For example, transmission powers may be selected to ensure that a femto power level in a desired area is above a threshold level for a certain percentage of devices, that a femto power level is below a threshold and/or a macro power level is above a threshold in an undesired coverage area for a certain percentage of devices, and/or the like. The power adjusting component 210 may select a power adjustment value for one or more of the femto base stations 110 that achieves the desired coverage condition(s). In addition, the power optimizing component 200 may iteratively adjust the transmission power of one or more of the femto base stations 110 according to further measurement reports received from the mobile device 120A, which may travel over a service area.

As discussed above, the power optimizing component 200 may again be implemented in a particular base station and/or as a distributed algorithm across multiple base stations (e.g., for determining a power at each base station), implemented as a centralized entity within a disparate anchor base station or other network component (e.g., for determining power for a plurality of base stations), and/or the like. As also discussed above, in some designs, the power optimizing component 200 may iteratively adjust transmission power of one or more of the femto base stations 110 after NLPC is performed for the femto base stations 110. Moreover, in this regard, the power optimizing component 200 may be implemented separately from a power optimizing component that performs the NLPC.

In one example design, the mobile device 120A may initiate a voice call or otherwise connect to one of the femto base stations 110. The mobile device 120A may periodically send MRMs to the power optimizing component 200 (e.g., or a component or base station that implements the power optimizing component 200), for example, that include a common pilot indicator channel (CPICH) received signal code power (RSCP) and/or CPICH energy over interference (E_{cp}/Iₒ) of primary synchronization codes (PSC) specified in an MCM as it moves among locations in the service area.

The measurement report receiving component 204 may obtain the MRMs, and extract path loss (PL) to locations covered by the mobile device 120A, as well as Iₒ of macro base station 160 at the locations based on the parameters in the MRM. Using these measurements, the power adjusting component 210 may determine power adjustment values based on complying with coverage conditions and/or optionally protection conditions, which may be respectively determined or generated by the FUE coverage condition component 206 and/or the MUE protection condition component 208. In some designs, power adjusting component 210 may determine transmit powers according to a power calibration algorithm.

For example, the FUE coverage condition component 206 may set a coordinated coverage condition according to the following formula, measured in terms of FUE E_{cp}/Iₒ:

$$\frac{1}{{J}_{fue}} {\sum }_{j = i}^{{J}_{fue}} Φ ( \frac{{max}_{n} {α}_{n}^{( j )} {p}_{n}}{{\sum }_{n = 1}^{{N}_{femto}} {β}_{n}^{( j )} + {I}_{o , macro}^{( j )} + {N}_{o}} \geq γ tar , fue ) \geq xtar , fue \%$$

where Φ is a 0-1 indicator function, J_{fue} is the number of points in a path taken by the mobile device 120A (e.g., on a technician walk) for FUE coverage evaluation, αₙ and βₙ are coefficients determined based at least in part on PL, loading factor, etc., pₙ is an element in a transmit power matrix p, N_{femto} is a number of femtocells with known locations (e.g., femto base stations 110, and/or related cells), I_{o,macro}^{(j)} is an Iₒ measurement related to a macrocell (e.g., macro base station 160) at point j, Nₒ may be thermal noise as measured, γtar, fue is a minimum FUE E_{cp}/Iₒ for a coverage condition at a femtocell (e.g., a femto base station 110), and xtar, fue % is a desired percentage of J_{fue} points that satisfy γtar, fue.

Similarly, where MUE protection is desired for multiple areas of femtocell coverage, the MUE protection condition component 208 may set a protection condition according to the following formula, measured in terms of MUE E_{cp}/Iₒ:

$$\frac{1}{{J}_{mue}} {\sum }_{j = i}^{{J}_{mue}} Φ ( \frac{{\sum }_{n = 1}^{{N}_{macro}} {ɛ}^{( j )} {p}_{macro}}{{\sum }_{n = 1}^{{N}_{macro}} {μ}_{n}^{( j )} {p}_{macro} + {\sum }_{n = 1}^{{N}_{femto}} {λ}_{n}^{( j )} {p}_{n} + {N}_{o}} \geq γ tar , mue ) \geq xtar , mue \%$$

where Φ is a 0-1 indicator function, J ₘᵤₑ is the number of points in a path taken by the mobile device 120A (e.g., on a technician walk) for MUE protection evaluation, εₙ, μₙ, and λₙ are coefficients determined based at least in part on PL, loading factor, etc., p_{macro} is a transmit power of the macro base station 160 at location j in power matrix p, N_{macro} is a number of neighboring macrocells with known locations (e.g., nearby or hearable cells provided by the macro base station 160 and/or one or more other base stations), γtar, mue is a minimum MUE E_{cp}/Iₒ to limit interference to the macro base station 160, and xtar,mue % is a desired percentage of Jₘᵤₑ points that satisfy γtar,mue.

Here, the power adjusting component 210 may solve a linear program, for example, using the FUE coverage condition component 206 based at least in part on the foregoing formula to determine transmission power for one of the femto base stations 110 that satisfies the coverage condition. For example, the linear program may comprise the following algorithm steps:
1. At each step k, set η=η^{[k]},k=1, . . . , K

$$\begin{matrix}2. & Solve & & & \\ & & {min}_{p} & {w}_{{I}_{o} {p}^{[ k ]}}^{T} & \\ & & subject to & \frac{{\sum }_{n = 1}^{{N}_{femto}} {α}_{n}^{( j )} {p}_{n}^{[ k ]}}{{\sum }_{n = 1}^{{N}_{femto}} {β}_{n}^{( j )} {p}_{n}^{[ k ]} + {I}_{o , macro}^{( j )} + {N}_{o}} \geq {η}^{[ k ]} , & j = 1 , … , {J}_{fue} \\ & & & 0 \leq p \leq {p}_{max} 1 & \\ & & & {P}_{diff} p \leq 0 & \end{matrix}$$

using the FUE coverage condition component 206.

$$3. Sub {p}^{[ k ]} in \frac{1}{{J}_{fue}} {\sum }_{j = i}^{{J}_{fue}} Φ ( \frac{{max}_{n} {α}_{n}^{( j )} {p}_{n}}{{\sum }_{n = 1}^{{N}_{femto}} {β}_{n}^{( j )} {p}_{n} + {I}_{o , macro}^{( j )} + {N}_{o}} \geq γ tar , fue ) \geq xtar , fue \%$$

$$and find {x}^{[ k ]} \%$$

4. Evaluate 1−x^{[k]} %=f(η). If monotonically decreasing, optimal power for femto base station 110 may be given by the solution of the linear program with η_{tar,fue}=f⁻¹(1−xtar, fue %).
   Here, p is the transport power vector (p₁, . . . , p_{Nfemto})^{T}, w_{I}_{ₒ} is a weighing factor to protect MUE from neighboring femto interference, P_{diff} is a size N_{femto}(N_{femto}−1)×N_{femto} power differential matrix, 0≦p≦pₘₐₓ1 limits a maximum transmission power, and P_{diff}p≦0 controls a power difference between femtocells to prevent uplink-downlink imbalance issues. Since the constraint in the above is linear, the program becomes linear. In addition, where the max function, above, is replaced with its sum, the multi-step linear program based centralized power calibration algorithm solves the soft handover case. The power adjusting component 210 may accordingly adjust transmission power of one or more of the femto base stations 110.

In some designs, the power adjusting component 210 may exclude locations of least desirable points encountered by the mobile device 120A from the power calibration. For FUE, these points may be the xtar, fue % largest femtocell PL+macrocell Iₒ, and for MUE may be xtar,mue % smallest femtocell PL+macrocell Iₒ. Once some points are excluded, in this example, the power adjusting component 210 may determine a transmission power for one of the femto base stations 110 based at least in part on solving the following linear program:

$$\begin{matrix}\begin{matrix}{min}_{p} & {1}^{T} p & \\ subject to & \frac{{\sum }_{n = 1}^{{N}_{femto}} {α}_{n}^{( j )} {p}_{n}}{{\sum }_{n = 1}^{{N}_{femto}} {β}_{n}^{( j )} {p}_{n} + {I}_{o , macro}^{( j )} + {N}_{o}} \geq γ tar , fue , & j = 1 , … , {J}_{fue}^{′}\end{matrix} & ( 1 ) \\ \begin{matrix}\frac{{\sum }_{n = 1}^{{N}_{macro}} {ɛ}^{( j )} {p}_{macro}}{{\sum }_{n = 1}^{{N}_{macro}} {μ}_{n}^{( j )} {p}_{macro} + {\sum }_{n = 1}^{{N}_{femto}} {λ}_{n}^{( j )} {p}_{n} + {N}_{o}} \geq γ tar , mue , & j = 1 , … , {J}_{mue}^{′} \\ 0 \leq p \leq {p}_{max} 1 & \\ {P}_{diff} p \leq 0 & \end{matrix} & ( 2 )\end{matrix}$$

where the FUE coverage condition component 206 may be used to solve condition (1), and the MUE protection condition component 208 may be used to solve condition (2) for a given transmission power, as described, and J′_{fue} and J′ₘᵤₑ are the number of remaining points after excluding some according to the femtocell PL+macrocell Iₒ, given xtar,fue % and xtar,mue %, as described. The power adjusting component 210 may determine a power for one of the femto base stations 110 according to this linear program, which may provide flexibility in trading-off between FUE coverage and MUE protection performance.

In some designs, constraints for FUE coverage and MUE protection may be relaxed to determine a tradeoff of between femto coverage and leakage to other areas. For example, the FUE coverage condition component 206 may solve the following conditions for given transmission powers:

$$\frac{{\sum }_{n = 1}^{{N}_{femto}} {α}_{j , n} {p}_{n}}{{\sum }_{n = 1}^{{N}_{femto}} {θα}_{j , n} {p}_{n} + {N}_{t , j}} \geq γ tar , fue ( 1 - {u}_{j} )$$

$$0 \leq p \leq {p}_{max} 1$$

$${P}_{diff} p \leq 0$$

where θ is a parameter denoting the assumed loading factor of the macrocells. The MUE protection condition component 208 may solve the following conditions for given transmission powers:

$${\sum }_{n = 1}^{{N}_{femto}} {β}_{j , n} {p}_{n} \leq ρ {N}_{t , j} ( 1 + {v}_{j} )$$

$$0 \leq p \leq {p}_{max} 1$$

$${P}_{diff} p \leq 0$$

where Nₜ may represent thermal noise (e.g., as measured during a technician walk), uⱼ≧0, vⱼ≧0, and ρ is a parameter regulating the allowed interference level. Using such relaxed requirements may allow the FUE coverage condition component 206 and the MUE protection condition component 208 to generate a non-empty set. Moreover, for example, power adjusting component 210 may utilize a cost function L-0 norm to determine which constraint to relax more, such as the following:

$${min}_{p , u , v} {c}_{1} {‖ u ‖}_{0} + {c}_{2} {‖ v ‖}_{0}$$

$$femto coverage \text{:} {N}_{t , j}^{- 1} {\sum }_{n = 1}^{{N}_{femto}} {α}_{j , n} {p}_{n} \geq \frac{γ tar , fue}{1 - θγ tar , fue} ( 1 - {u}_{j} )$$

$$macro protection \text{:} {\sum }_{n = 1}^{{N}_{femto}} {β}_{j , n} {p}_{n} \leq ρ {N}_{t} ( 1 - {v}_{j} )$$

where 0≦u≦1 and v≧0. Additionally or alternatively, the power adjusting component 210 may utilize a cost function L-1 norm to determine which constraint to relax more, such as the following:

$${min}_{p} {c}_{1} {‖ u ‖}_{1} + {c}_{2} {‖ v ‖}_{1}$$

$$femto coverage \text{:} {N}_{t , j}^{- 1} {\sum }_{n = 1}^{{N}_{femto}} {α}_{j , n} {p}_{n} \geq \frac{{γ}_{trgt , fue}}{1 - θ {γ}_{trgt , fue}} ( 1 - {u}_{j} )$$

$$macro protection \text{:} {\sum }_{n = 1}^{{N}_{femto}} {β}_{j , n} {p}_{n} \leq ρ {N}_{t} ( 1 - {v}_{j} )$$

where u≧0 and v≧0, which transforms the problem into a problem solvable using linear programming. For hard handover, for example, the problem may become:

$$\frac{{α}_{j , k} {p}_{k}}{{\sum }_{n = 1}^{{N}_{femto}} {β}_{j , n} {p}_{n} + {N}_{t , j}} \geq γ tar , fue ( 1 + {u}_{j} )$$

where k is an iteratively determined index. Changing the ratio of c₁ to c₂ generates a curve for the tradeoff between femto-coverage and interference. A suitable ratio of c₁ to c₂ may accordingly be selected to achieve the desired tradeoff

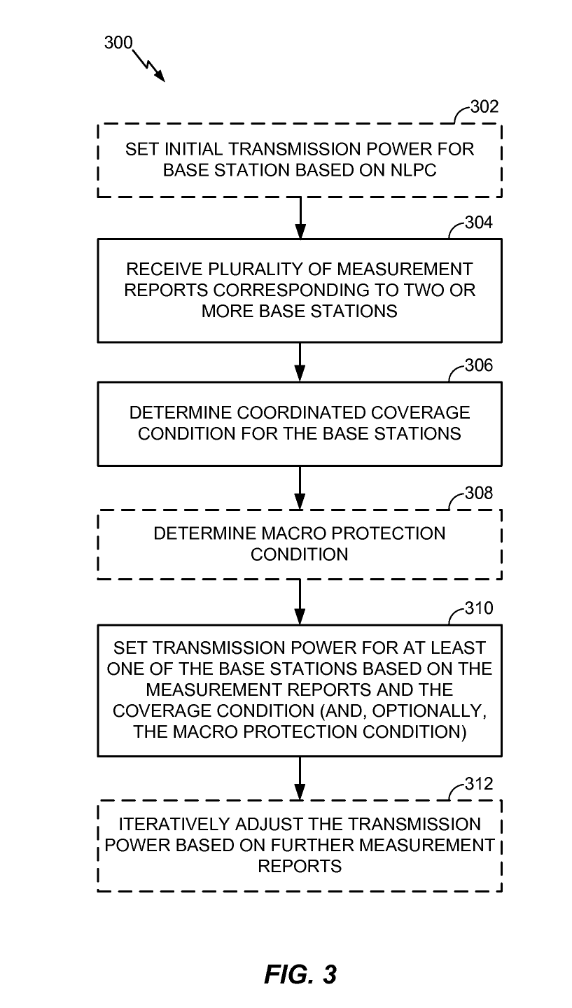

FIG. 3 illustrates an example methodology 300 for coordinating transmission power for small-coverage base stations deployed in a wireless communication network. The methodology 300 may be employed, for example, by either of the femto base stations 110, or some other attached or stand-alone central entity, as discussed above.

As shown in FIG. 3, in some embodiments, an initial transmission power for at least one base station (e.g., one of the femto base stations 110) may be optionally set based on an NLM-based power calibration (NLPC) (block 302), and a plurality of measurement reports corresponding to two or more base stations may be received (e.g., for the femto base station 110A and the femto base station 110B) (block 304). As discussed above, the measurement reports for each base station may include signal quality information gathered by a mobile device (e.g., the mobile device 120A) at a location associated with a coverage region of the base station. In addition, some of the measurement reports may be received directly from the mobile device, while others may be received indirectly from the mobile device via a corresponding serving base station.

A coordinated coverage condition may be determined for the base stations (block 306), and, in some embodiments, a macro protection condition may also be determined (e.g., for the macro base station 160) (block 308). In some embodiments, determining the coverage condition may include computing coverage conditions for a plurality of points along a route of the mobile device between the base stations. The coverage condition may also be determined based on a target transmission power for providing coverage for each base station at a threshold level. Further, the base stations may be femtocell base stations deployed in concert to supplement coverage of a macrocell base station in the wireless communication network.

A transmission power for at least one of the base stations may then be set based on the measurement reports and the coverage condition, and, optionally, the macro protection condition (block 310). Subsequently, the transmission power for the at least one base station may be iteratively adjusted, if desired, based on further measurement reports received over a period of time (block 312). Iteratively adjusting the transmission power may be based on a percentage of the further measurement reports being above or below a threshold.

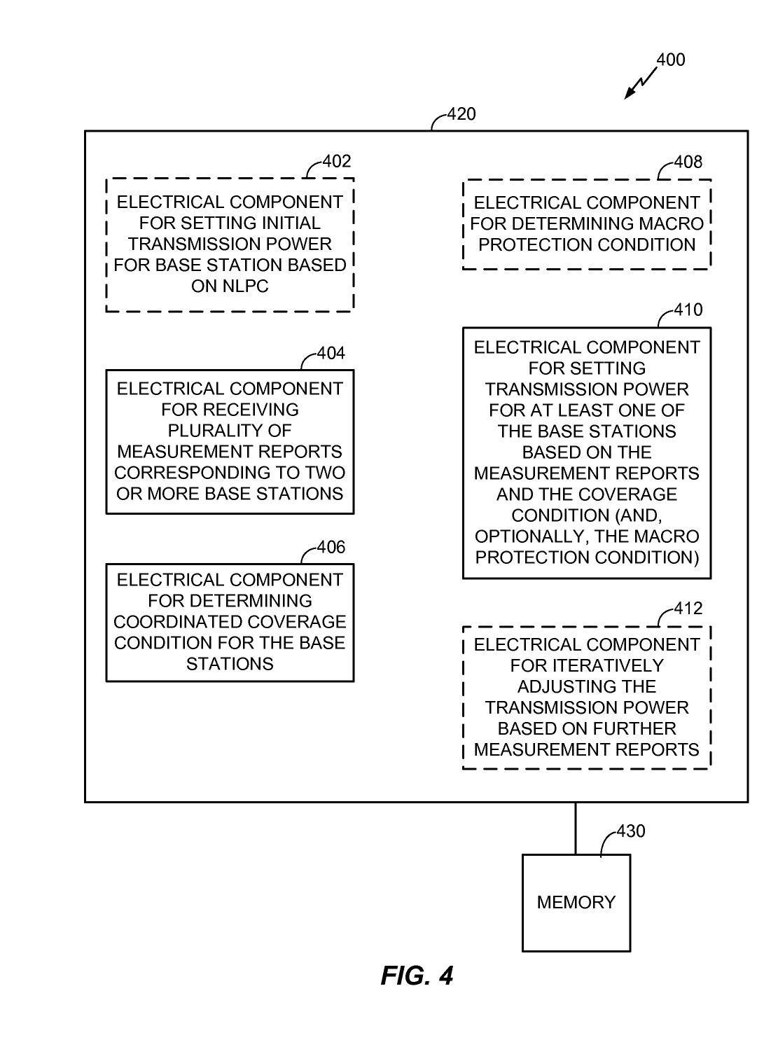

Turning now to FIG. 4, an example system 400 is illustrated that facilitates coordinating transmission power for small-coverage base stations deployed in a wireless communication network. For example, system 400 can reside at least partially within a base station, other central entity, etc. It is to be appreciated that system 400 is represented as including functional blocks, which can be functional blocks that represent functions implemented by a processor in conjunction with software or firmware, for example. System 400 includes a logical grouping 420 of electrical components that can act in conjunction with each other and a memory 430 to achieve the illustrated functions.

For example, logical grouping 420 may include an electrical component for setting an initial transmission power for at least one base station based on NLPC (block 402), an electrical component for receiving a plurality of measurement reports corresponding to two or more base stations (block 404), an electrical component for determining a coordinated coverage condition for the base stations (block 406), an electrical component for determining a macro protection condition (block 408), an electrical component for setting a transmission power for at least one of the base stations based on the measurement reports and the coverage condition, and, optionally, the macro protection condition (block 410), and/or an electrical component for iteratively adjusting the transmission power for the at least one base station based on further measurement reports received over a period of time (block 412). While shown as being external to memory 430, it is to be understood that one or more of the electrical components 404-412 may exist within memory 430.

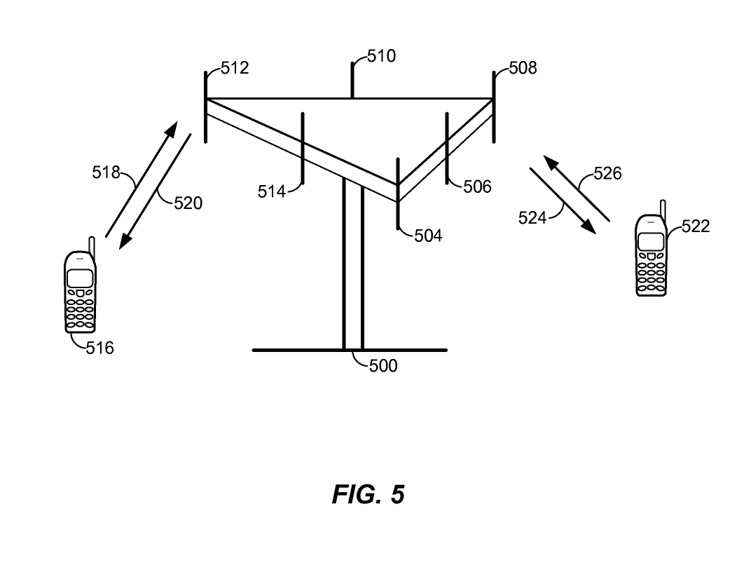

FIG. 5 illustrates an example access point base station 500 for use in a multiple-access wireless communication system according to one or more embodiments. As shown, the base station 500 may include multiple antenna groups, one including antennas 504 and 506, another including antennas 508 and 510, and an additional including antennas 512 and 514. In FIG. 5, only two antennas are shown for each antenna group, however, it will be appreciated that more or fewer antennas may be utilized for each antenna group. As is further shown, an access terminal 516 is in communication with the antennas 512 and 514, where the antennas 512 and 514 transmit information to the access terminal 516 over a forward link 520 and receive information from the access terminal 516 over a reverse link 518. An access terminal 522 is in communication with the antennas 506 and 508, where the antennas 506 and 508 transmit information to the access terminal 522 over a forward link 526 and receive information from the access terminal 522 over a reverse link 524. In a Frequency Division Duplex (FDD) system, the communication links 518, 520, 524 and 526 may use different frequencies for communication. For example, the forward link 520 may use a different frequency then that used by the reverse link 518.

Each group of antennas and/or the area in which they are designed to communicate is often referred to as a sector of the base station. In the embodiment shown, the antenna groups are each designed to communicate to the access terminals 516, 522 in a given sector of the areas covered by the base station 500.

In communication over the forward links 520 and 526, the transmitting antennas of the base station 500 may utilize beamforming in order to improve the signal-to-noise ratio of the forward links for the different access terminals 516 and 522. A base station using beamforming to transmit to access terminals scattered randomly through its coverage may cause less interference to access terminals in neighboring cells than a base station transmitting through a single antenna to all its access terminals.

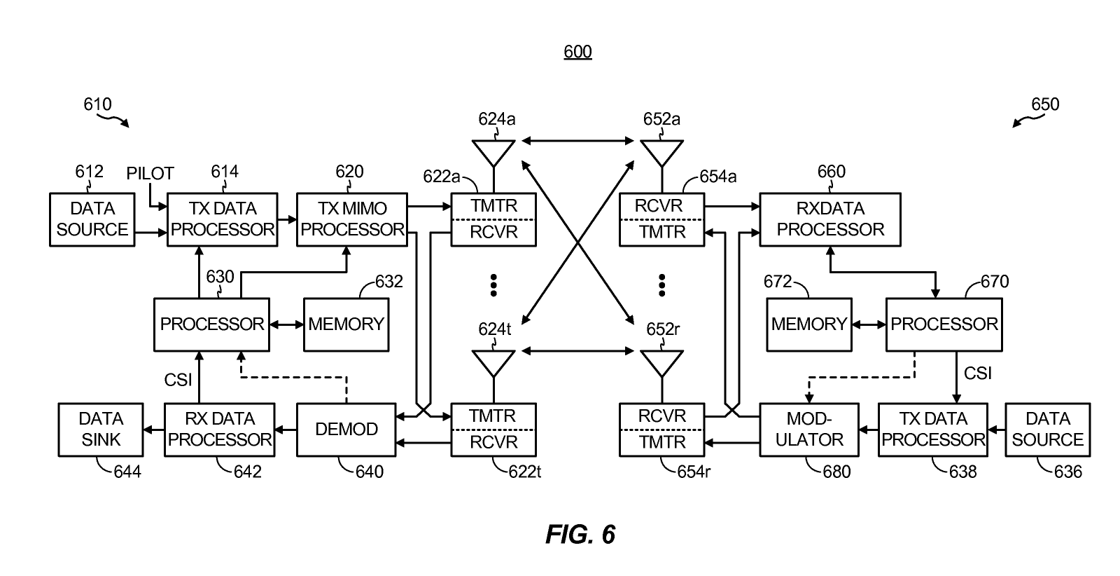

FIG. 6 is a block diagram of an example transmitter system 610 (e.g., a base station) and a receiver system 650 (e.g., an access terminal) in a MIMO system 600 that may be used according to one or more embodiments. At the transmitter system 610, traffic data for a number of data streams is provided from a data source 612 to a transmit (TX) data processor 614. In one embodiment, the transmitter system 610 and/or the receiver system 650 may employ the systems of FIGS. 1, 2, and 4, and/or the method of FIG. 3 described herein to facilitate wireless communication therebetween. For example, components or functions of the systems and/or methods described herein may be part of a memory 632 and/or 672, or processors 630 and/or 670 described below, or may be executed by processors 630 and/or 670 to perform the disclosed functions.

In one example design, each data stream may be transmitted over a respective transmit antenna. TX data processor 614 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by the processor 630.

The modulation symbols for all data streams are then provided to a TX MIMO processor 620, which can further process the modulation symbols (e.g., for OFDM). TX MIMO processor 620 then provides NT modulation symbol streams to NT transmitters (TMTR) 622a through 622t. In certain embodiments, TX MIMO processor 620 may apply beamforming weights to the symbols of the data streams and to the antenna from which the symbol is being transmitted.

Each transmitter 622 receives and processes a respective symbol stream to provide one or more analog signals, and further conditions (e.g., amplifies, filters, and upconverts) the analog signals to provide a modulated signal suitable for transmission over the MIMO channel. NT modulated signals from NT transmitters 622a through 622t are then transmitted from NT antennas 624a through 624t, respectively.

At receiver system 650, the transmitted modulated signals are received by NR antennas 652a through 652r and the received signal from each antenna 652 is provided to a respective receiver (RCVR) 654a through 654r. Each receiver 654 conditions (e.g., filters, amplifies, and downconverts) a respective received signal, digitizes the conditioned signal to provide samples, and further processes the samples to provide a corresponding “received” symbol stream.

An RX data processor 660 then receives and processes the NR received symbol streams from NR receivers 654 based on a particular receiver processing technique to provide NT “detected” symbol streams. The RX data processor 660 then demodulates, deinterleaves, and decodes each detected symbol stream to recover the traffic data for the data stream. The processing by RX data processor 660 is complementary to that performed by TX MIMO processor 620 and TX data processor 614 at transmitter system 610.

A processor 670 periodically determines which pre-coding matrix to use (discussed below). Processor 670 formulates a reverse link message comprising a matrix index portion and a rank value portion.

The reverse link message can comprise various types of information regarding the communication link and/or the received data stream. The reverse link message is then processed by a TX data processor 638, which also receives traffic data for a number of data streams from a data source 636, modulated by a modulator 680, conditioned by transmitters 654a through 654r, and transmitted back to transmitter system 610.

At transmitter system 610, the modulated signals from receiver system 650 are received by antennas 624, conditioned by receivers 622, demodulated by a demodulator 640, processed by an RX data processor 642 to extract the reserve link message transmitted by the receiver system 650, and, when appropriate, stored in a data sink 644. Processor 630 then determines which pre-coding matrix to use for determining the beamforming weights then processes the extracted message.

Processors 630 and 670 may direct (e.g., control, coordinate, manage, etc.) operation at transmitter system 610 and receiver system 650, respectively. Respective processors 630 and 670 can be associated with memory 632 and 672 that store program codes and data. Processors 630 and 670 can also perform computations to derive frequency and impulse response estimates for the uplink and downlink, respectively.

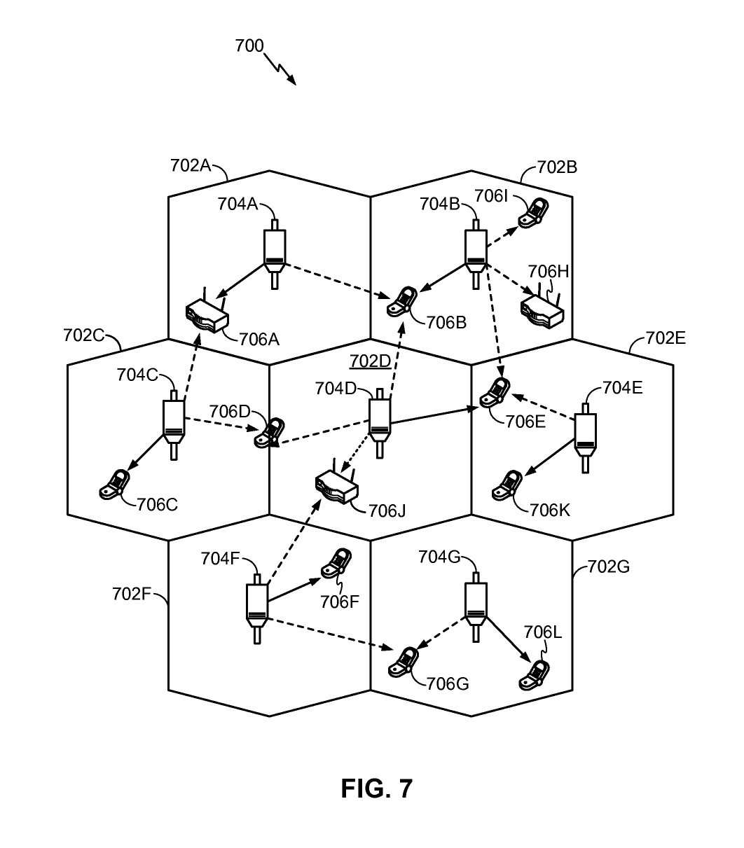

FIG. 7 illustrates another example wireless communication system 700, configured to support a number of users, in which the techniques herein may be implemented. The system 700 provides communication for multiple cells 702, such as, for example, macro cells 702A-702G, with each cell being serviced by a corresponding access node 704 (e.g., access nodes 704A-704G). As shown in FIG. 7, access terminals 706 (e.g., access terminals 706A-706L) may be dispersed at various locations throughout the system over time. Each access terminal 706 may communicate with one or more access nodes 704 on a forward link (FL) and/or a reverse link (RL) at a given moment, depending upon whether the access terminal 706 is active and whether it is in soft handoff, for example. The wireless communication system 700 may provide service over a large geographic region. For example, macro cells 702A-702G may cover a few blocks in a neighborhood.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, electrical components, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor.

Accordingly, an embodiment of the invention may include a computer readable media embodying a method for coordinating small-coverage base stations deployed in a wireless communication network. Accordingly, the invention is not intended to be limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for coordinating transmission power for small-coverage base stations deployed in a wireless communication network, comprising:
receiving a plurality of measurement reports corresponding to two or more base stations;
determining a coordinated coverage condition for the base stations; and
setting a transmission power for at least one of the base stations based on the measurement reports and the coverage condition.

2. The method of claim 1, wherein the measurement reports for each base station include signal quality information gathered by a mobile device at a location associated with a coverage region of the base station.

3. The method of claim 2, wherein at least one of the measurement reports is received directly from the mobile device.

4. The method of claim 2, wherein at least one of the measurement reports is received indirectly from the mobile device via a corresponding serving base station.

5. The method of claim 2, wherein determining the coverage condition comprises computing coverage conditions for a plurality of points along a route of the mobile device between the base stations.

6. The method of claim 1, wherein the coverage condition is determined based on a target transmission power for providing coverage for each base station at a threshold level.

7. The method of claim 1, further comprising determining a macro protection condition, wherein setting the transmission power is further based on the macro protection condition.

8. The method of claim 1, further comprising setting an initial transmission power for the at least one base stations based on a network listen module (NLM)-based power calibration (NLPC).

9. The method of claim 1, further comprising iteratively adjusting the transmission power for the at least one base stations based on further measurement reports received over a period of time.

10. The method of claim 9, wherein iteratively adjusting the transmission power is based on a percentage of the further measurement reports satisfying the coverage condition.

11. The method of claim 1, wherein the base stations are femtocell base stations deployed in concert to supplement coverage of a macrocell base station in the wireless communication network.

12. An apparatus for coordinating transmission power for small-coverage base stations deployed in a wireless communication network, comprising:
at least one processor configured to:
receive a plurality of measurement reports corresponding to two or more base stations,
determine a coordinated coverage condition for the base stations, and
set a transmission power for at least one of the base stations based on the measurement reports and the coverage condition; and
memory coupled to the at least one processor.

13. The apparatus of claim 12, wherein the measurement reports for each base station include signal quality information gathered by a mobile device at a location associated with a coverage region of the base station.

14. The apparatus of claim 13, wherein the at least one processor is configured to receive at least one of the measurement reports directly from the mobile device.

15. The apparatus of claim 13, wherein the at least one processor is configured to receive at least one of the measurement reports indirectly from the mobile device via a corresponding serving base station.

16. The apparatus of claim 13, wherein the at least one processor is configured to determine the coverage condition by computing coverage conditions for a plurality of points along a route of the mobile device between the base stations.

17. The apparatus of claim 12, wherein the at least one processor is configured to determine the coverage condition based on a target transmission power for providing coverage for each base station at a threshold level.

18. The apparatus of claim 12, wherein the at least one processor is further configured to determine a macro protection condition, and to set the transmission power based further on the macro protection condition.

19. The apparatus of claim 12, wherein the at least one processor is further configured to set an initial transmission power for the at least one base stations based on a network listen module (NLM)-based power calibration (NLPC).

20. The apparatus of claim 12, wherein the at least one processor is further configured to iteratively adjust the transmission power for the at least one base stations based on further measurement reports received over a period of time.

21. The apparatus of claim 20, wherein the at least one processor is further configured to iteratively adjust the transmission power based on a percentage of the further measurement reports satisfying the coverage condition.

22. The apparatus of claim 12, wherein the base stations are femtocell base stations deployed in concert to supplement coverage of a macrocell base station in the wireless communication network.

23. An apparatus for coordinating transmission power for small-coverage base stations deployed in a wireless communication network, comprising:
means for receiving a plurality of measurement reports corresponding to two or more base stations;
means for determining a coordinated coverage condition for the base stations; and
means for setting a transmission power for at least one of the base stations based on the measurement reports and the coverage condition.

24. The apparatus of claim 23, wherein the measurement reports for each base station include signal quality information gathered by a mobile device at a location associated with a coverage region of the base station.

25. The apparatus of claim 24, wherein the means for receiving comprises means for receiving at least one of the measurement reports directly from the mobile device.

26. The apparatus of claim 24, wherein the means for receiving comprises means for receiving at least one of the measurement reports indirectly from the mobile device via a corresponding serving base station.

27. The apparatus of claim 24, wherein the means for determining the coverage condition comprises means for computing coverage conditions for a plurality of points along a route of the mobile device between the base stations.

28. The apparatus of claim 23, wherein the means for determining the coverage condition comprises means for determining the coverage condition based on a target transmission power for providing coverage for each base station at a threshold level.

29. The apparatus of claim 23, further comprising means for determining a macro protection condition, wherein the means for setting the transmission power comprises means for setting the transmission power based further on the macro protection condition.

30. The apparatus of claim 23, further comprising means for setting an initial transmission power for the at least one base stations based on a network listen module (NLM)-based power calibration (NLPC).

31. The apparatus of claim 23, further comprising means for iteratively adjusting the transmission power for the at least one base stations based on further measurement reports received over a period of time.

32. The apparatus of claim 31, wherein the means for iteratively adjusting the transmission power comprises means for adjusting the transmission power based on a percentage of the further measurement reports satisfying the coverage condition.

33. The apparatus of claim 23, wherein the base stations are femtocell base stations deployed in concert to supplement coverage of a macrocell base station in the wireless communication network.

34. A non-transitory computer-readable medium comprising code, which, when executed by a processor, causes the processor to perform operations for coordinating transmission power for small-coverage base stations deployed in a wireless communication network, the computer-readable medium comprising:
code for receiving a plurality of measurement reports corresponding to two or more base stations;
code for determining a coordinated coverage condition for the base stations; and
code for setting a transmission power for at least one of the base stations based on the measurement reports and the coverage condition.

35. The computer-readable medium of claim 34, wherein the measurement reports for each base station include signal quality information gathered by a mobile device at a location associated with a coverage region of the base station.

36. The computer-readable medium of claim 35, wherein the code for receiving comprises code for receiving at least one of the measurement reports directly from the mobile device.

37. The computer-readable medium of claim 35, wherein the code for receiving comprises code for receiving at least one of the measurement reports indirectly from the mobile device via a corresponding serving base station.

38. The computer-readable medium of claim 35, wherein the code for determining the coverage condition comprises code for computing coverage conditions for a plurality of points along a route of the mobile device between the base stations.

39. The computer-readable medium of claim 34, wherein the code for determining the coverage condition comprises code for determining the coverage condition based on a target transmission power for providing coverage for each base station at a threshold level.

40. The computer-readable medium of claim 34, further comprising code for determining a macro protection condition, wherein the code for setting the transmission power comprises code for setting the transmission power based further on the macro protection condition.

41. The computer-readable medium of claim 34, further comprising code for setting an initial transmission power for the at least one base stations based on a network listen module (NLM)-based power calibration (NLPC).

42. The computer-readable medium of claim 34, further comprising code for iteratively adjusting the transmission power for the at least one base stations based on further measurement reports received over a period of time.

43. The computer-readable medium of claim 42, wherein the code for iteratively adjusting the transmission power comprises code for adjusting the transmission power based on a percentage of the further measurement reports satisfying the coverage condition.

44. The computer-readable medium of claim 34, wherein the base stations are femtocell base stations deployed in concert to supplement coverage of a macrocell base station in the wireless communication network.
